(19) United States
(12) Patent Application Publication
(10) Pub. No.: US 2015/0356623 A1
(43) Pub. Date: Dec. 10, 2015

(54) System And Method For Recommending Customized Tourism Content Based On Collecting And Structurizing Of Unstructured Tourism Data

(71) Applicant: Korea Advanced Institute of Science and Technology, Daejeon (KR)

(72) Inventors: Dong Man Lee, Daejeon (KR); Byoung Heon Shin, Daejeon (KR)

(21) Appl. No.: 14/694,195

(22) Filed: Apr. 23, 2015

(30) Foreign Application Priority Data
Jun. 9, 2014 (KR) 10-2014-0069412

(51) Int. Cl. G06Q 30/02; G06Q 50/00; G06Q 10/02

(52) U.S. Cl. CPC G06Q 30/0269; G06Q 10/025; G06Q 50/01

(57) ABSTRACT

A customized tourism content recommending system is provided which collects and structurizes unstructured tourism data. The customized tourism content recommending system includes a data collecting unit, a data structurizing unit, a user emotion analyzing unit, and a schedule providing unit. The data collecting unit collects unstructured data about a tourism at one time, and the data structurizing unit structurizes the unstructured data, collected by the data collecting unit, based on one or more of a time, a place, or an occasion. The user emotion analyzing unit analyzes an emotion of a user about an individual tourism experience. The schedule providing unit reflects the analysis of the emotion analyzing unit about the user's emotion, derives a customized travel schedule from the data, structurized by the data structurizing unit, according to one or more of the time, the place, or the occasion, and provides the derived result to the user.

### CROSS-REFERENCE TO RELATED APPLICATIONS

A claim for priority under 35 U.S.C. §119 is made to Korean Patent Application No. 10-2014-0069412 filed Jun. 9, 2014, in the Korean Intellectual Property Office, the entire contents of which are hereby incorporated by reference.

### BACKGROUND

Embodiments of the inventive concepts described herein relate to system and method for recommending customized tourism content based on collecting and structurizing of unstructured tourism data, and more particularly, relate to customized tourism content recommending system and method capable of recommending customized schedule by collecting unstructured tourism data and structurizing it based on a time, a place, and an occasion.

As an economic scale is enlarged and the standard of living is enhanced, the tourist industry is coming a long way. In particular, free overseas trip, an increase in international trade, and an increase in economic scale in the globalization enable the tourist industry to create higher added value than other industries, so more jobs are created. Hence, the tourist industry may be one of the biggest industries in the world.

Tourism businesses around the world provide tourism services. However, none of the tourism businesses provides a unified platform service that is based on tourism contents from various data sources reflecting tourist trends and industries which are absolutely necessary for a business. Accordingly, marketing to contact with customers has been done independently through the following management of a simple on-line channel such as a website, a blog, etc. Several approaches which provide a travel schedule or a plan are proposed based on the reservation of a user including transportation and accommodation.

Since providing a predetermined schedule, a conventional travel schedule providing service is not suitable for temporal and spatial requirements and tour purposes of users. A conventional technique for sharing tourism contents through a social network service enables users to share their experiences, but it does not provide customized contents technically.

Moreover, users want to travel according to different conditions: travel time, place and occasion (TPO). Based on existing approaches, each user has to create his/her own schedule by searching for relevant contents in the Internet based on such TPO, thereby consuming a lot of time and effort.

### SUMMARY

Embodiments of the inventive concepts provide customized tourism content recommending system and method capable of automatically generating and recommending a travel schedule fit to a tourism requirement of a user by storing and structurizing unstructured tourism data, collected from a social network service, a blog, a tourism information site, etc., and analyzing and reflecting user's emotion about each tourism experience.

One aspect of embodiments of the inventive concept is directed to provide a customized tourism content recommending system is provided which collects and structurizes unstructured tourism data. The customized tourism content recommending system may include a data collecting unit, a data structurizing unit, a user emotion analyzing unit, and a schedule providing unit. The data collecting unit may collect unstructured data about a tourism at one time, and the data structurizing unit may structurize the unstructured data, collected by the data collecting unit, based on one or more of a time, a place, or an occasion. The user emotion analyzing unit may analyze an emotion of a user about an individual tourism experience. The schedule providing unit may reflect the analysis of the emotion analysis unit about the user's emotion, may derive a customized travel schedule from the data, structurized by the data structurizing unit, according to one or more of the time, the place, or the occasion, and may provide the derived result to the user.

The data collecting unit may automatically and periodically collect different forms of unstructured contents about the tourism, which are made on various social network services or webpages, using a customized crawler.

The data structurizing unit may structurize the unstructured data using an ontology for defining a keyword or a correlation between keywords according to one or more of the time, the place, or the occasion about the tourism.

The data structurizing unit may store the unstructured data at database in a structurization form according to the time, the place, or the occasion.

The user emotion analyzing unit may access the database to determine whether the user's emotion about the tourism experience is positive or negative and updates the database according to the determination result.

The schedule providing unit may generate the travel schedule, fit to user's tourism requirement, according to one or more of a place, a time to stay about the place, a moving time between places, or necessary expenses and may recommend the travel schedule to the user.

Another aspect of embodiments of the inventive concept is directed to provide a customized tourism content recommending method which collects and structurizes unstructured tourism data. The customized tourism content recommending method may include collecting unstructured data about a tourism at one time; structurizing the collected unstructured data based on one or more of a time, a place, or an occasion; analyzing the emotion of a user about an individual tourism experience; and reflecting the analysis about the user's emotion and deriving a customized travel schedule according to one or more of the time, the place, or the occasion, to provide the derived result to the user.

The collecting of unstructured data may include automatically and periodically collecting different forms of unstructured contents about the tourism, which are made on various social network services or webpages, using a customized crawler.

The structurizing of the collected unstructured data may include structurizing the unstructured data using an ontology for defining a keyword or a correlation between keywords according to one or more of the time, the place, or the occasion about the tourism.

The structurizing of the unstructured data may include extracting a keyword associated with the tourism from the unstructured data based on the ontology; and storing the keyword at a database in a structurization form according to one or more of the time, the place, or the occasion.

The analysis of an emotion of a user may include accessing the database to determine whether the user's emotion about an individual tourism experience is positive or negative and updating the database according to the determination result.

The deriving of a customized travel schedule may include generating the travel schedule, fit to user's tourism requirement, according to one or more of a place, a time to stay about the place, a moving time between places, or necessary expenses and may recommend the travel schedule to the user.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a block diagram schematically illustrating a customized tourism content recommending system according to an exemplary embodiment of the inventive concept;

FIG. 2 is a configuration diagram schematically illustrating a tourism schedule providing system according to an exemplary embodiment of the inventive concept;

FIG. 3 is a flow chart schematically illustrating a customized tourism context recommending method according to an exemplary embodiment of the inventive concept; and

FIG. 4 is a flow chart schematically illustrating a data structurizing method according to an exemplary embodiment of the inventive concept.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

The inventive concept may provide a system that automatically collects and structurizes various tourism contents registered at a social network service and a blog in an unstructured form and automatically derive a customized travel schedule according to the collected and structurized contents when a user selects tourism time, place, and occasion, thereby minimizing inconvenience of the user and providing high satisfaction level of contents.

Below, an embodiment of the inventive concept will be more fully described with reference to accompanying drawings.

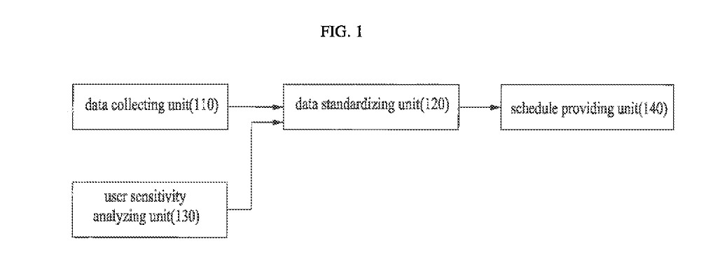

FIG. 1 is a block diagram schematically illustrating a customized tourism content recommending system according to an exemplary embodiment of the inventive concept.

Referring to FIG. 1, a customized tourism content recommending system contains a data collecting unit 110, a data structurizing unit 120, a user emotion anaiyzing unit 130, and a schedule providing unit 140.

The data collecting unit 110 synthetically collects pieces of unstructured tourism content data that are made on various sorts of web services such as social network services, blogs, etc. For example, the data collecting unit 110 may automatically and periodically collect different forms of tourism contents, which are made on various social network services or webpages, using a customized crawler.

Here, the crawler may be used to automatically search for and index a variety of information on webpages. A user does not obtain information by clicking each link of a webpage, but the crawler iteratively performs operations of synthetically searching for a new webpage according to a manner previously stored at a computer program and finding and indexing new information using the found result. Since data is collected using a customized tourism crawler, the huge amount of tourism data is collected in a lump.

The data structurizing unit 120 structurizes the collected unstructured data based one or more of a time, a place, or an occasion (TPO). Here, the data structurizing unit 120 may structurize the collected unstructured data according to three methods: time, place, and occasion. Alternatively, the data structurizing unit 120 may determine a criterion according to a user need. That is, the data structurizing unit 120 may structurize the collected unstructured data according to the TPO using ontology defining a keyword or correlation between keywords at a tourism content according to the TPO.

At this time, the ontology may be formal and explicit specification about shared conceptualization in an interested area and may be concept-type database including such concepts. In other words, the ontology may be a model that expresses what persons agrees to through discussion with respect to five senses of a world, conceptually and so as to be processed by a computer, and it may be a technique for explicitly defining concept types or constraint conditions for the use. Also, since denoting agreed knowledge, the ontology is the concept that is agreed by all group members, not any one person, and a program may interpret the ontology. Thus, various kinds of structurizations may exist.

For structurization, the data structurizing unit 120 defines correlation between words included in the collected unstructured data and extracts information corresponding to one or more of a time, a place, or an occasion. Also, the data structurizing unit 120 stores the structurized data at database.

The user emotion analyzing unit 130 analyzes user's emotion about individual tourism experience thus collected. The user emotion analyzing unit 130 accesses the database to determine whether the user's emotion about the individual tourism experience is positive or negative and updates the database according to the determination result.

The schedule providing unit 140 reflects the analysis of the emotion analyzing unit 130 about the user's emotion and derives a customized travel schedule from the data, structurized by the data structurizing unit 120, according to one or more of a time, a place, or an occasion. The schedule providing unit 140 provides the derived result to the user. That is, the schedule providing unit 140 generates a TPO-based decision tree using the structurized data, derives a customized travel schedule by performing a scheduling algorithm based on a tourism requirement of the user, and provides the derived result to the user.

Also, the schedule providing unit 140 generates a travel schedule, fit to user's tourism requirements (restrictions against time and place and a travel purpose), according to one or more of a place, a time to stay about each place, a moving time between places, or necessary expenses and recommends the travel schedule to the user. This will be more fully described later.

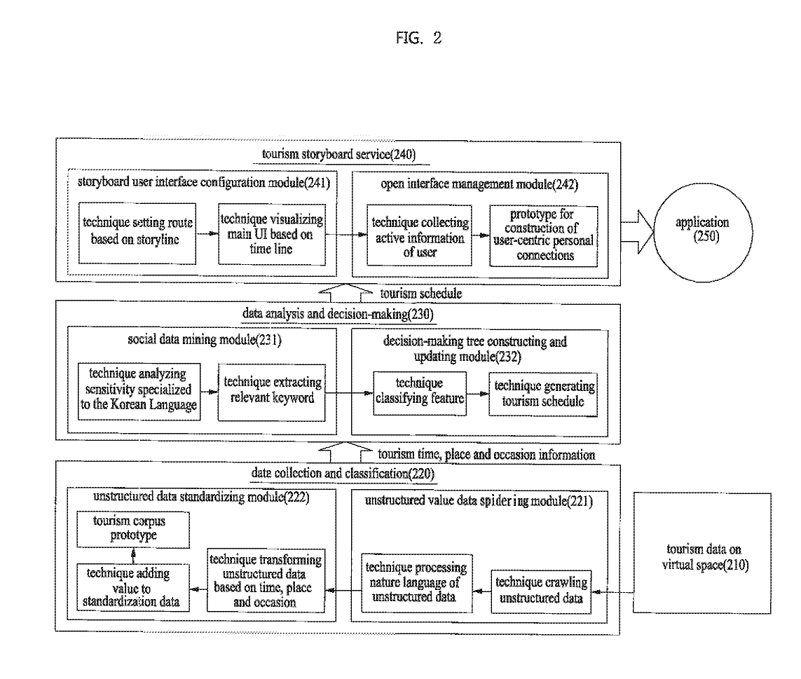

FIG. 2 is a configuration diagram schematically illustrating a tourism schedule providing system according to an exemplary embodiment of the inventive concept.

Referring to FIG. 2, a tourism schedule providing system contains a data collecting and classifying unit 220, a data analyzing and decision making unit 230, and a tourism storyboard service unit 240.

The data collecting and classifying unit 220 includes an unstructured value data spidering module 221 and an unstructured data structurizing module 222.

The unstructured value data spidering module 221 collects tourism data 210 from a virtual space such as a social network service or a blog, etc. at a lump using an unstructured data crawling technique and performs natural language processing about unstructured data.

The unstructured data structurizing module 222 transforms the unstructured data based on a time, a place, and an occasion and adds a value to structurized data to form tourism corpus prototype. Here, it is possible to analyze morpheme of a characterized keyword of a tourism content based on a corpus and to construct ontology expressing an area name, an event name, etc.

The data analyzing and decision making unit 230 contains a social data mining module 231 and a decision-making tree constructing and updating module 232. The data analyzing and decision making unit 230 is provided with tourism TPO information from the data collecting and classifying unit 220 and analyzes and reflects user's emotion to generate a tourism schedule.

The social data mining module 231 analyzes user's emotion using an emotion analysis technique specialized to a native language (e.g., the Korean Language) and extracts a relevant keyword. At this time, the social data mining module 231 defines profile information needed to select tourism preference, such as a sex, an age, etc., for differentiated customized recommendation and extracts tourism experience knowledge and interest keywords that users using collective intelligence empathize with.

The decision-making tree constructing and updating module 232 constructs a flexible decision tree to provide a user-customized tourism schedule and classifies data using a technique for classifying features such as tourism time, place and occasion. Also, it is possible to generate a tourism schedule through a scheduling algorithm that uses a TPO-based cost function. That is, the decision-making tree constructing and updating module 232 generates the tourism schedule and provides it to a storyboard user interface (UI) configuration module 241.

The tourism storyboard service unit 240 contains the storyboard user interface configuration module 241 and an open interface management module 242. The tourism storyboard service unit 240 is provided with information about a tourism schedule from the data analyzing and decision making unit 230 as storyboard configuration information.

The storyboard user interface configuration module 241 sets a route based on a storyline and visualizes a main user interface based on a timeline.

The open interface management module 242 collects active information of a user and forms prototype constructing user-centric personal connections. At this time, it is possible to analyze definition and requirement of a user-adaptive social storyboard UI/UX and extract tourism experience knowledge and interest keywords that users using collective intelligence empathize with.

Accordingly, the storyboard prototype thus formed is provided to the user via an application 250.

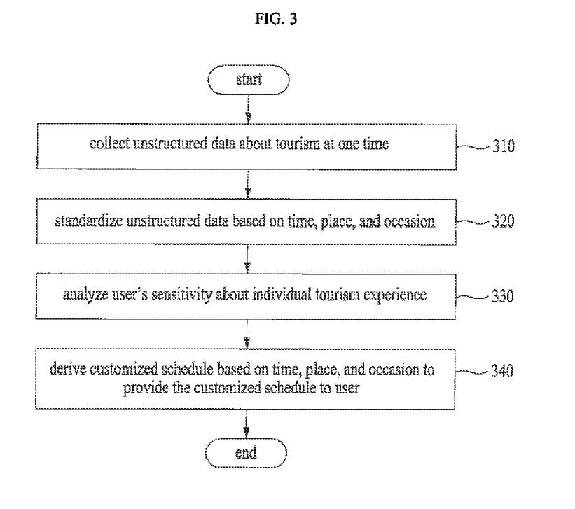

FIG. 3 is a flow chart schematically illustrating a customized tourism context recommending method according to an exemplary embodiment of the inventive concept.

Referring to FIG. 3, a customized tourism content recommending system may recommend customized tourism content by collecting and structurizing pieces of unstructured tourism data.

In step 310, a data collecting unit of the customized tourism content recommending system synthetically collects unstructured data about unstructured tourism content. At the time, the data collecting unit automatically and periodically collect different forms of tourism contents, which are made on various social network services or webpages, using a customized crawler.

In step 320, a data structurizing unit structurizes the collected unstructured data associated with tourism, based at least one of a time, a place, or an occasion (TPO). At this time, the data structurizing unit structurizes the unstructured data according to three methods: time, place, and occasion. Alternatively, it is possible to use any other criterion other than the TPO according to a user need. Also, the data structurizing unit structurizes the collected unstructured data according to the TPO using ontology defining a keyword or correlation between keywords at a tourism content with the TPO as the center.

In step S330, a user emotion analyzing unit analyzes user's emotion about individual tourism experience. Also, the user emotion analyzing unit accesses database to determine whether the user's emotion about the individual tourism experience is positive or negative and updates the database according to the determination result.

In step S340, a schedule providing unit derives a user-customized schedule according to one or more of a time, a place, or an occasion and provides a tourism schedule to a user. Thus, the schedule providing unit generates a travel schedule, fit to user's tourism requirements (restrictions against time and place and a travel purpose), according to one or more of a place, a time to stay about each place, a moving time between places, or necessary expenses and recommends the travel schedule to the user.

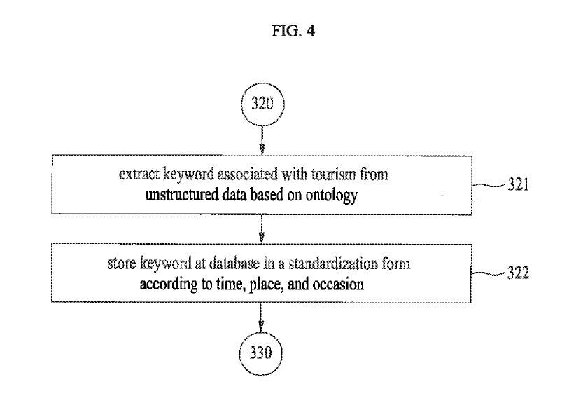

FIG. 4 is a flow chart schematically illustrating a data structurizing method according to an exemplary embodiment of the inventive concept.

Referring to FIG. 4, collected unstructured data may be structurized based on one or more of a time, a place, or an occasion.

In step 321, a data structurizing unit extracts a tourism-associated keyword from unstructured data, based on ontology. Here, the ontology may define a keyword or correlation between keywords, based on one or more of a time, a place, or an occasion.

Also, it is possible to analyze user's emotion using an emotion analysis technique specialized to a native language (e.g., the Korean Language) and extract a relevant keyword. At this time, it is possible to define profile information needed to select tourism preference, such as a sex, an age, etc., for differentiated customized recommendation and extract tourism experience knowledge and interest keywords that users using collective intelligence empathize with.

In step 322, the data structurizing unit stores data at database in the form of structurization according to one or more of a time, a place, or an occasion.

Afterwards, customized tourism contents fit to a user need about tourism may be recommended by accessing database to determine whether user's emotion about tourism experience is positive or negative and updating the database according to the determination result.

The units described herein may be implemented using hardware components, software components, or a combination thereof. For example, devices and components described therein may be implemented using one or more general-purpose or special purpose computers, such as, but not limited to, a processor, a controller, an arithmetic logic unit, a digital signal processor, a microcomputer, a field programmable gate array (FPGA), a programmable logic unit, a microprocessor or any other device capable of responding to and executing instructions in a defined manner. A processing device may run an operating system (OS) and one or more software applications that run on the OS. The processing device also may access, store, manipulate, process, and create data in response to execution of the software. For the sake of easy understanding, an embodiment of the inventive concept is exemplified as one processing device is used; however, one skilled in the art will appreciate that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The example embodiments may be recorded in non-transitory computer-readable media including program instructions to perform various operations embodied by a computer. The media may also include, alone or in combination with the program instructions, data files, data structures, and the like. The media and program instructions may be those specially designed and constructed for the purposes, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that specially store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be to act as one or more software modules in order to perform the operations of the above-described embodiments.

According to an exemplary embodiment of the inventive concept, it is possible to structurize and store unstructured tourism data, collected from a social network service, a blog, a tourism information site, etc., and analyze and reflect user's emotion about each tourism experience, thereby making it possible to automatically generate and recommend a travel schedule fit to a tourism requirement of a user. That is, user's inconvenience may be minimized.

As described above, though embodiments have been described in specific examples and drawings, it may be apparent to one skilled in the art that modifications or changes on the embodiments are variously made. For example, the described techniques may be performed in an order different from the methods described and/or described components such as systems, architectures, devices, and circuits may be combined in a manner different from a manner described above or may accomplish an appropriate result even though replaced or substituted by equivalents or other components.

While the inventive concept has been described with reference to exemplary embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A customized tourism content recommending system which collects and structurizes unstructured tourism data, comprising:
a data collecting unit configured to collect unstructured data about a tourism at one time;
a data structurizing unit configured to structurize the unstructured data, collected by the data collecting unit, based on one or more of a time, a place, or an occasion;
a user emotion analyzing unit configured to analyze an emotion of a user about an individual tourism experience; and
a schedule providing unit configured to reflect the analysis of the emotion analyzing unit about the user's emotion, to derive a customized travel schedule from the data, structurized by the data structurizing unit, according to one or more of the time, the place, or the occasion, and to provide the derived result to the user.

2. The customized tourism content recommending system of claim 1, wherein the data collecting unit automatically and periodically collects different forms of unstructured contents about the tourism, which are made on various social network services or webpages, using a customized crawler.

3. The customized tourism content recommending system of claim 1, wherein the data structurizing unit structurizes the unstructured data using an ontology for defining a keyword or a correlation between keywords according to one or more of the time, the place, or the occasion about the tourism.

4. The customized tourism content recommending system of claim 1, wherein the data structurizing unit stores the unstructured data at database in a structurization form according to the time, the place, or the occasion.

5. The customized tourism content recommending system of claim 4, wherein the user emotion analyzing unit accesses the database to determine whether the user's emotion about the tourism experience is positive or negative and updates the database according to the determination result.

6. The customized tourism content recommending system of claim 1, wherein the schedule providing unit generates the travel schedule, fit to user's tourism requirement, according to one or more of a place, a time to stay about the place, a moving time between places, or necessary expenses and recommends the travel schedule to the user.

7. A customized tourism content recommending method which collects and structurizes unstructured tourism data, comprising:
collecting unstructured data about a tourism at one time;
structurizing the collected unstructured data based on one or more of a time, a place, or an occasion;
analyzing an emotion of a user about an individual tourism experience; and
reflecting the analysis about the user's emotion and deriving a customized travel schedule according to one or more of the time, the place, or the occasion, to provide the derived result to the user.

8. The customized tourism content recommending method of claim 7, wherein the collecting of unstructured data comprises automatically and periodically collecting different forms of unstructured contents about the tourism, which are made on various social network services or webpages, using a customized crawler.

9. The customized tourism content recommending method of claim 7, wherein the structurizing of the collected unstructured data comprises structurizing the unstructured data using an ontology for defining a keyword or a correlation between keywords according to one or more of the time, the place, or the occasion about the tourism.

10. The customized tourism content recommending method of claim 9, wherein the structurizing of the unstructured data comprises:
extracting a keyword associated with the tourism from the unstructured data based on the ontology; and
storing the keyword at a database in a structurization form according to one or more of the time, the place, or the occasion.

11. The customized tourism content recommending method of claim 10, wherein the analyzing of an emotion of a user comprises accessing the database to determine whether the user's emotion about an individual tourism experience is positive or negative and updating the database according to the determination result.

12. The customized tourism content recommending method of claim 7, wherein the deriving of a customized travel schedule comprises generating the travel schedule, fit to user's tourism requirement, according to one or more of a place, a time to stay about the place, a moving time between places, or necessary expenses and recommending the travel schedule to the user.
